(19) United States
(12) Patent Application Publication
(10) Pub. No.: US 2026/0136433 A1
(43) Pub. Date: May 14, 2026

(54) GEOFENCED MISSION CRITICAL PUSH-TO-TALK (MCPTT) TALK GROUPS

(71) Applicant: T-Mobile USA, Inc., Bellevue, WA (US)

(72) Inventors: Mark J. Bonn, Granite Bay, CA (US); Muhammad Nauhman Gora, Irvine, CA (US); Jagannadha Anudeep Varma Datla, Kent, WA (US); Mallika S. Deshpande, Bellevue, WA (US)

(21) Appl. No.: 18/943,733

(22) Filed: Nov. 11, 2024

(51) Int. Cl. H04W 76/45; H04W 4/021; H04W 76/34

(52) U.S. Cl. CPC H04W 76/45; H04W 4/021; H04W 76/34

(57) ABSTRACT

The present invention relates to geofenced Mission Critical Push-to-Talk (MCPTT) talk groups. A dynamically joinable MCPTT talk group can be created in response to a request from an administrator. The request can indicate a geofence within which members can communicate and that the group is joinable by users whose mobile devices are within the geofence. A location estimate of a mobile device can be received and the device can be determined to be within the geofence based on the location estimate. In response to the determination that the device is within the geofence automatically, a user of the device can be added to the MCPTT talk group without selective addition of the user by the administrator.

### BACKGROUND

Mission Critical Push-to-Talk (MCPTT) talk groups enable efficient and reliable communication among the group’s members. To create a talk group, an administrator must identify the specific users whom he or she wishes to include. If new members are to be added, current members are to be removed, or the talk group is to be deleted entirely, these operations are typically performed through an additional request from the administrator. This manual process is time consuming, requiring administrators to meticulously update each user's status, which can be particularly burdensome in large organizations with frequent personnel changes. Additionally, the manual approach delays the responsiveness of the communication system, as administrators may not be able to promptly update the talk group during critical situations. This lag can hinder real-time coordination and decision-making, ultimately affecting the overall efficiency and reliability of mission-critical operations.

### BRIEF DESCRIPTION OF THE DRAWINGS

Detailed descriptions of implementations of the present invention will be described and explained through the use of the accompanying drawings.

FIG. 1 illustrates a wireless communications system that can implement aspects of the present technology.

FIG. 2 illustrates 5G core network functions (NFs) that can implement aspects of the present technology.

FIG. 3 illustrates a wireless communication architecture for providing MCPTT talk groups in accordance with aspects of the present technology.

FIG. 4 illustrates an application for providing MCPTT talk groups in accordance with aspects of the present technology.

FIG. 5 illustrates a method for provisioning a geofenced MCPTT talk group in accordance with aspects of the present technology.

FIGS. 6A-6C illustrate a response site where users are added to or removed from a geofenced MCPTT talk group in accordance with aspects of the present technology.

FIG. 7 illustrates a computer system in which at least some aspects of the present technology can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

MCPTT talk groups are used by companies to enable efficient and reliable communication among a group of employees. For example, MCPTT talk groups can be created to provide communication channels to a group of employees working together to accomplish a particular task. Typically, talk groups are created by an administrator who manually adds users to the talk group (e.g., by identifying them by their Mobile Station International Subscriber Directory Number (MSISDN) or their profile on an application that enables MCPTT talk groups). When new employees arrive to accomplish the task or old employees leave the site, for example, in response to shift changes or problems that require additional or different expertise, the administrator typically must add or remove the employees to/from the MCPTT talk group manually. This manual process is time consuming and can cause delays in providing communication to the members added to the MCPTT talk groups, thereby decreasing the speed at which workers can address the problem for which the MCPTT talk group was created.

Additionally, some problems can require involvement of employees across many different companies, for example, due to the wide range of services that are needed to address the problems. As a specific example, natural disasters can require emergency services from fire, police, medical, and other emergency personnel and repair services from telecommunications workers, electricians, and other service providers. In these cases, a single administrator (e.g., associated with a single company) can be responsible for managing membership in the MCPTT talk group. This can create challenges, however, because the administrator may not have information about the specific personnel within each company being dispatched to address the problem. Thus, the administrator may be incapable of providing access to the MCPTT talk group to specific personnel, or there may be significant delays in providing this access while the administrator determines the specific personnel that are being dispatched to address the problem.

Just as the administrator must typically add and remove members of an MCPTT talk group manually, when the problem has been solved and the MCPTT talk group is no longer needed, the administrator must typically delete the MCPTT talk group manually. This manual process can be time consuming and burdensome. And if the administrator forgets to delete the MCPTT talk group, the MCPTT talk group can crowd the application dashboard of members included within the MCPTT talk group. Alternatively, the MCPTT talk group can utilize application resources (e.g., resources used to maintain the membership in the MCPTT talk group) even though the MCPTT talk group is no longer useful, thereby resulting in waste.

To address these challenges and others, the present technology relates to a geofenced MCPTT talk group that members can be added to or removed from without an explicit request from an administrator of the MCPTT talk group to do so. For example, after the administrator creates the MCPTT talk group, users can be automatically added to the MCPTT talk group when the users enter a geofence within which members of the MCPTT talk group are able to communicate with one another. The geofence can be specified by the administrator when creating the MCPTT talk group and can correspond to a location of a problem to be addressed by the members of the MCPTT talk group. When a user enters the geofence, the user can be notified that the MCPTT talk group is joinable. For example, the name of the MCPTT talk group can be broadcast to the user. If the user chooses to join the talk group, the user can be added as a member such that the user can communicate with other members using the MCPTT talk group. The user can be added as a member without a specific request from the administrator, thus reducing the management burden on the administrator and decreasing the time required to provide communication to new users arriving to the geofence.

Users can also be removed from the MCPTT talk group without an explicit request to do so from the administrator of the MCPTT talk group. For example, when a user within the MCPTT talk group leaves the geofence within which they are able to communicate with the other members, the user can be removed as a member of the MCPTT talk group such that the talk group can no longer be used by the user to communicate with the other members. Like the addition of users, the removal of the user need not require a request from the administrator.

The geofence associated with the MCPTT talk group can be updated over time to change the location in which the MCPTT talk group can be joined and used for communication. In aspects, the MCPTT talk group can be updated based on a change in the location of the problem that members of the MCPTT talk group are addressing. As a specific example, the MCPTT talk group can be created to provide a mode of communication to emergency and service personnel responding to an extreme weather event (e.g., a hurricane, tsunami, storm, blizzard, tornado, heat wave, or flood) and the location of the geofence can change as weather data about the location of the extreme weather event changes. In some cases, the update to the geofence can be in response to receiving a location of the extreme weather event from a weather application. In this way, the location of the geofence can be updated to correspond to the areas affected by the extreme weather event without requiring constant oversight by the administrator to update the location of the geofence.

The present technology also provides for an MCPTT talk group that can be provisioned with an expiration time when the MCPTT talk group is created. For example, the administrator can specify an expiration time of the MCPTT talk group when a request to create the group is made. Then, in response to reaching the expiration time, the MCPTT talk group can be deleted without any additional request from the administrator. In this way, the burden of managing the MCPTT talk group on the administrator can be reduced.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail to avoid unnecessarily obscuring the descriptions of examples.

### Wireless Communications System

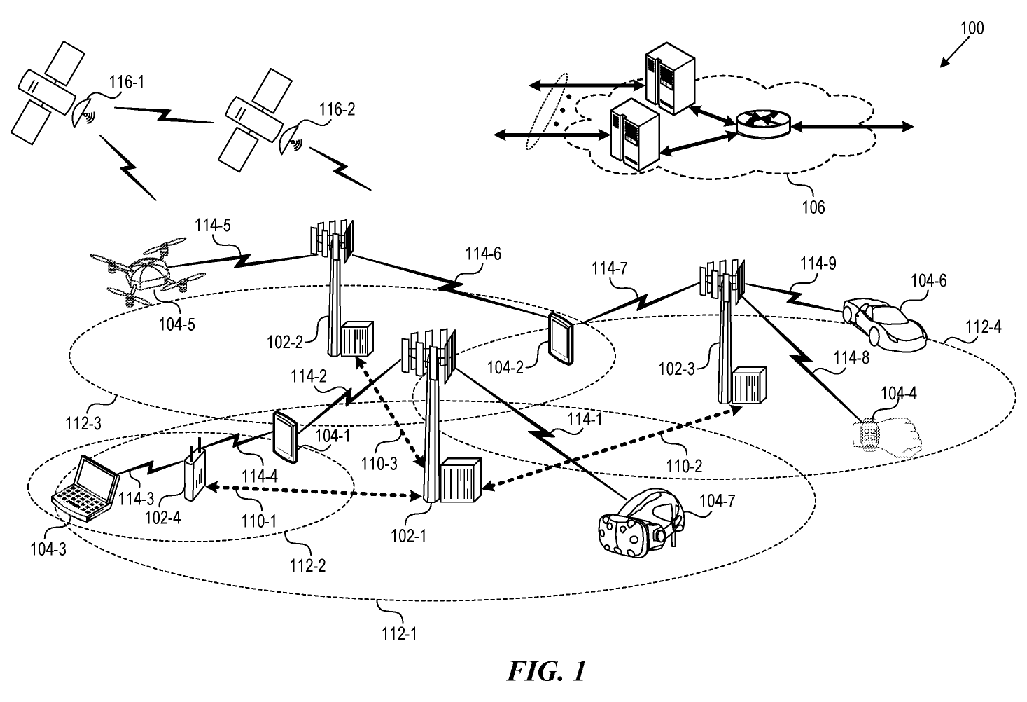

FIG. 1 is a block diagram that illustrates a wireless telecommunication network 100 (“network 100”) in which aspects of the disclosed technology are incorporated. The network 100 includes base stations 102-1 through 85 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 gigahertz (GHz) or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, Internet Protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid Automatic Repeat Request (HARQ) to provide retransmission at the MAC layer to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of the network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The DL transmissions can also be called forward link transmissions while the UL transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultra-high quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and core architecture to achieve Control and User Plane Separation (CUPS) and achieve extremely low user plane latency. In yet another example of 6G, the network 100 can implement a converged Wi-Fi and core architecture to increase and improve indoor coverage.

### 5G Core NFs

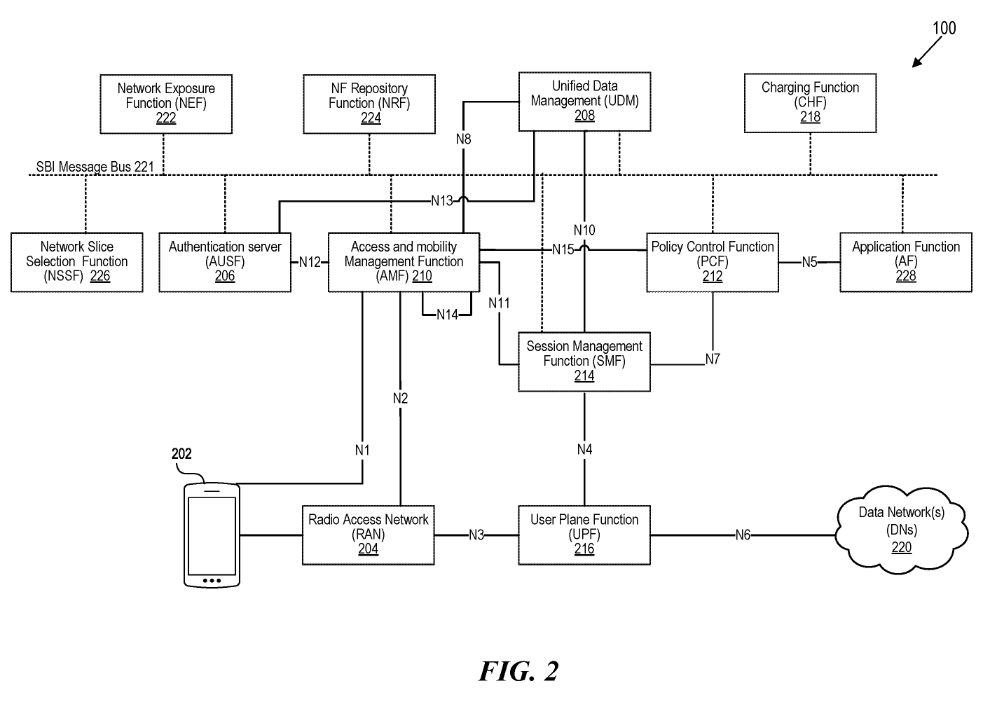

FIG. 2 illustrates 5G core NFs 200 that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator’s infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### MCPTT Communication

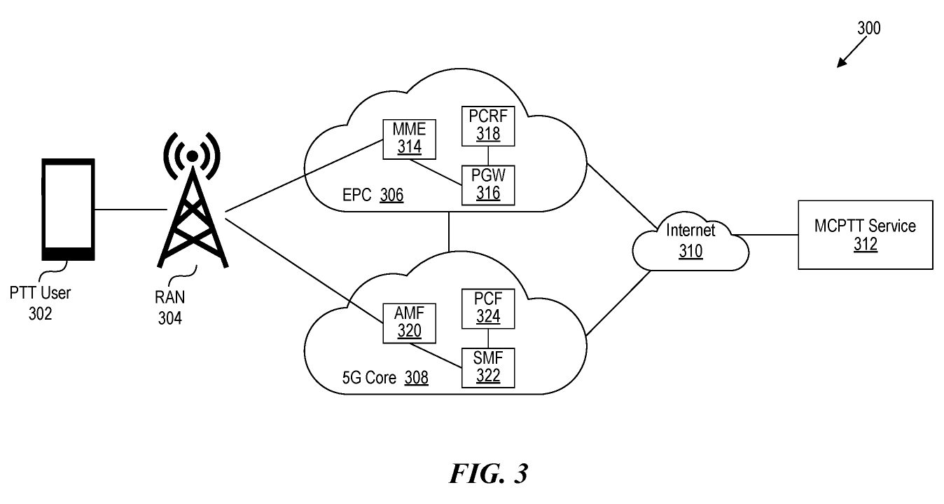

FIG. 3 illustrates a wireless communication architecture 300 for providing an MCPTT talk group in accordance with aspects of the present technology. The wireless communication architecture 300 includes a wireless device 302, a RAN 304, a telecommunications network core, such as an evolved packet core (EPC) 306 or a 5G network core 308, the Internet 310, and an MCPTT service 312. The wireless device 302 can be used to communicate in an MCPTT talk group hosted on servers of the MCPTT service 312. The wireless device 302 can be provided MCPTT capability through an application associated with the MCPTT service 312. In other cases, the MCPTT capability can be natively provided on the device (e.g., a rugged device with a Push-to-Talk (PTT) button and MCPTT capability). The MCPTT capability can be provided through an over-the-top application by a third-party service provider. Thus, the wireless device 302 can access the MCPTT service 312 through data transmitted on the network core and transmitted over the Internet 310 using an Internet data bearer.

The wireless device 302 can include a UE registered with a mobile network operator (MNO). In some cases, the wireless device 302 can be a rugged UE implemented in a durable housing and designed to be utilized in the field and on job sites. In aspects, the rugged UE can include a dedicated PTT button. The wireless device 302 can include an application associated with the MCPTT service 312 that can be used to access MCPTT talk groups. For example, the application can include the various groups of which a user of the wireless device 302 is a member. The user can access the groups through the application and communicate data to the MCPTT service 312 (e.g., through the RAN 304, the network core, and the Internet 310) to be communicated to the other members of the group through the application.

The wireless device 302 can connect to the RAN 304 over the air. Through the RAN 304, the wireless device 302 can communicate with the network core to communicate data through the network. The wireless device 302 can communicate using any generation of a wireless communication technology. As illustrated, the wireless device 302 can communicate using the EPC 306 or the 5G network core 308. In the case of the EPC 306, the wireless device 302 can be authenticated at a Mobility Management Entity (MME) 314. The MME 314 can be responsible for managing and controlling the access and mobility of the wireless device 302. The MME 314 handles key functions such as user authentication, session management, and mobility management. It authenticates users by interacting with the HSS. For session management, the MME 314 establishes and maintains the bearer paths for data transmission, coordinating with a Packet Data Network Gateway (PGW) 316 to ensure seamless data flow. In terms of mobility management, the MME 314 tracks the location of mobile devices, facilitating handovers between eNodeBs to maintain continuous connectivity as users move.

Once authenticated, data can be communicated to/from the wireless device 302 through the PGW 316. The PGW 316 can interface between the mobile network and external packet data networks, such as the Internet 310. The PGW 316 can allocate IP address allocation to user devices, enforce policies, and support charging functions. The PGW 316 manages the data traffic by routing user data packets to and from the MCPTT service 312 through the Internet 310. The PGW 316 can enforce QoS policies, which prioritize different types of traffic to maintain optimal network performance. The operations of the PGW 316 can be based on policies and rules maintained in the Policy and Charging Rules Function (PCRF) 318.

The 5G network core 308 can similarly be used to communicate data, as discussed above. For example, an AMF 320 can manage access and mobility of the wireless device 302 similar to the MME 314, an SMF 322 can handle data sessions and communication with the MCPTT service 312 through the Internet 310 similar to the PGW 316, and a PCF 324 can be used to determine policy decisions associated with the wireless device 302 similar to the PCRF 318. The data can be communicated on the user plane of the 5G network core 308 to reach the MCPTT service 312 through the Internet 310.

Data communicated to/from the wireless device 302 in accordance with an MCPTT talk group can be communicated over the Internet 310 to interface between the network core and the MCPTT service 312. For example, voice data or management data (e.g., provisioning talk groups or providing other application control data) can be communicated between the wireless device 302 and the MCPTT service 312 as data packets. In some cases, the data packets can be communicated over the Internet through direct connect links to the MCPTT service 312, allowing for higher speed transmission.

The MCPTT service 312 can provide the functionality associated with the MCPTT communication. For example, the MCPTT service 312 can maintain user accounts, maintain the characteristics or membership of different MCPTT talk groups, and relay signaling and media between different devices communicating using MCPTT talk groups. MCPTT communication can thus be provided to the wireless device 302 through a cloud service accessible through the network core.

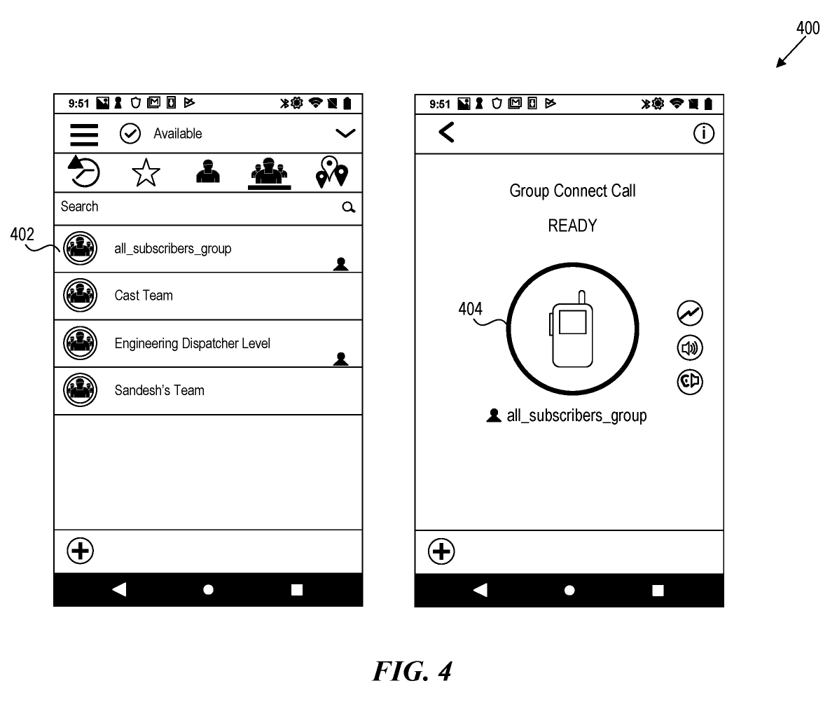

FIG. 4 illustrates an application 400 for providing MCPTT talk groups in accordance with aspects of the present technology. The application 400 can operate on a wireless device in communication with the MCPTT service. As illustrated, the application 400 provides an indication of MCPTT groups 402 of which the user of the wireless device is a member. Each of the MCPTT groups 402 can have a title by which they are identified and include a different set of members. The user can select one of the MCPTT groups 402 to use for actively communicating. For example, the user can receive audio communicated from other members in the group and transmit audio to other members of the group. The communication can be provided with PTT functionality such that audio is only transmitted to other members of the MCPTT group when a talk button 404 is pressed. The talk button 404 can be provided on the display of the wireless device through the application 400 or as a dedicated physical button on the wireless device (e.g., a dedicated PTT button on a rugged device).

### Geofenced MCPTT Talk Groups

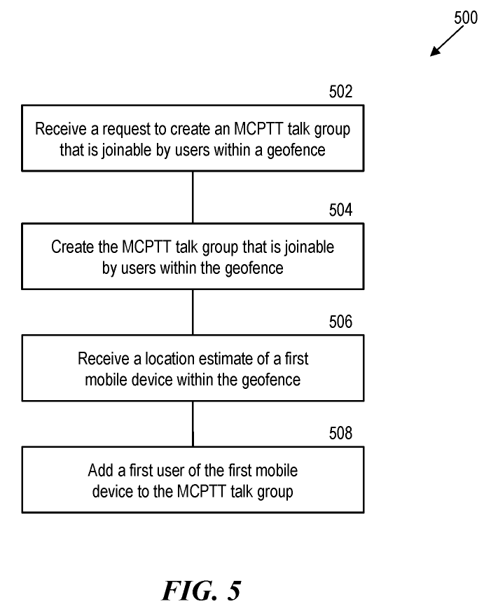

FIG. 5 illustrates a method 500 for provisioning a geofenced MCPTT talk group in accordance with aspects of the present technology. Although illustrated in a particular configuration, one or more operations of the method 500 may be omitted, repeated, or reorganized. Additionally, the method 500 may include other operations not illustrated in FIG. 5—for example, operations detailed in one or more other methods described herein.

At 502, a request to create an MCPTT talk group that is joinable by users within a geofence is received. The request can be initiated by an administrator of the MCPTT talk group. The administrator can be a user that wishes to participate in the MCPTT talk group or a separate user that does not intend to join the MCPTT talk group. Moreover, the request can be initiated from the mobile device on which the user is provided the MCPTT service (e.g., through the MCPTT application running on the mobile device). The request can indicate that the MCPTT talk group is to be created as a dynamic talk group whose membership can be altered without explicit direction from the administrator. In contrast to previous MCPTT talk groups that each member of the talk group must be explicitly added to or removed from by the administrator (e.g., often by identifying the member by their MSISDN or another credential), the MCPTT talk group can be joined by users themselves when the users enter the geofence. Similarly, users can be removed from the MCPTT talk group automatically (e.g., without additional action by the administrator) when the users exit the geofence. In aspects, the administrator is provided the option of whether to make the MCPTT talk group dynamic or static such that the administrator must individually add or remove members through explicit action. Given that with dynamic MCPTT talk groups, users can be added without explicit direction from the administrator, the administrator can request to create the MCPTT talk group with no members such that the group is empty, allowing members to be added dynamically over time. In other cases, the administrator can provision a first set of members to the MCPTT talk group but leave the group open to be joinable by other users within the geofence.

The administrator can specify characteristics of the MCPTT talk group through the request. For example, the administrator can indicate a location of the geofence within which the MCPTT talk group is joinable or can be used to communicate with other members. In aspects, the administrator can indicate the location of the geofence by providing coordinates that define the geofence. As a particular example, the administrator can provide a set of coordinates, and the geofence can be provisioned as a circle having the set of coordinates as its center. The administrator can specify other characteristics of the geofence, such as the size of the geofence (e.g., by providing a value corresponding to the radius of the circular geofence). The location of the geofence can be updatable over time (e.g., by additional communication from the administrator or communication with a separate application). Thus, the location of the geofence indicated in the request can be an initial location of the geofence. In other cases, the location of the geofence is static over time.

In some cases, the geofence can correspond to an impact zone (or predicted impact zone) of an extreme weather event. In this case, the administrator can provide an indication of the extreme weather event (e.g., by providing a location of the weather event or a name of the weather event) and the location of the geofence can be pulled from a weather monitoring application that tracks the location of the extreme weather event. For example, the initial location of the geofence can be the location of a centroid of a hurricane and, as the hurricane moves over time, the location of the geofence can be moved to correspond to the centroid of the hurricane. The movement of the geofence can occur without additional direction from the administrator (e.g., beyond initially setting the geofence to correspond to the updatable location of the weather event from the weather application), thereby allowing the geofence to correspond to the area in need of services without requiring constant updates from the administrator.

The administrator can also specify a title of the MCPTT talk group within the request. In aspects, the title of the talk group can be used to identify the MCPTT talk group as joinable to one or more users within the geofence. Moreover, the title can be used to identify the talk group on a dashboard of the MCPTT talk group to allow users to distinguish between multiple MCPTT talk groups of which they are members. In some cases, the title of the MCPTT talk group can be altered at a later time (e.g., by the administrator).

The administrator can request that the MCPTT talk group will automatically expire at an expiration time. The expiration time can be indicated by the administrator in the request to create the MCPTT talk group or during a later communication with the administrator. In instances when an expiration time is provided by the administrator, the MCPTT talk group can be established such that it is automatically deleted without further direction from the administrator when the expiration time is reached.

At 504, and in response to receiving the request to create the MCPTT talk group that is joinable by users within the geofence, the MCPTT talk group can be created such that users can be dynamically added without additional direction from the administrator. The MCPTT talk group can be created by a service provider of the MCPTT service. For example, the service provider can create the MCPTT talk group in accordance with the characteristics specified by the administrator to provide a channel for members of the MCPTT talk group to communicate with one another. An indication of the MCPTT talk group can be stored in a server managed by the MCPTT service provider. Any characteristics specified by the administrator can similarly be stored in association with the MCPTT talk group. For example, the server can store the title of the MCPTT talk group, the geofence associated with the MCPTT talk group, any policies for joining the MCPTT talk group, such as the MCPTT talk group being dynamically joinable by the user within the geofence (e.g., with permission from the administrator required or without permission from the administrator), an expiration time of the MCPTT talk group, and so on. Any further requests from the administrator or other authorized entity (e.g., the weather application, a user that joins the MCPTT talk group, a user that is removed from the MCPTT talk group) to alter the characteristics of the MCPTT talk group can similarly be stored in the server. Thus, the server can be referenced to determine appropriate action for managing the MCPTT talk group, including its membership, deletion, and other properties, in accordance with the direction of the administrator.

Once the MCPTT talk group is created, the members of the MCPTT talk group can have an indication of the MCPTT talk group on an application associated with the MCPTT service. For example, the title of the MCPTT talk group can be displayed on the user’s device when running the application. Similarly, the user can communicate with other members of the MCPTT talk group through the talk group when it is active on their application.

At 506, a location estimate of a first mobile device within the geofence is received. The location estimate can indicate that the first mobile device is located within the geofence associated with the MCPTT talk group. In aspects, the location estimate can be received through a location update request from the network or the MCPTT service. For example, the location update request can be issued by the network or the MCPTT service in response to operations on these respective services. In other cases, the location update request can include pings to the mobile device issued at predetermined intervals or in response to other events. The location estimate can alternatively or additionally be provided to the MCPTT service through a push from the device to provide its location to the MCPTT service. For example, the MCPTT application running on the mobile device can initiate a transmission of the location of the mobile device at predetermined intervals, in response to particular events, or at any other time. The location estimate can be determined by the device or the network using any number of methods, such as Global Navigation Satellite System (GNSS) techniques, triangulation, or any other technique.

At 508, and in response to receiving the location estimate of the first mobile device indicating that it is located within the geofence, a first user of the first mobile device can be added to the MCPTT talk group without additional direction from the administrator. In aspects, the first user can be added in response to requesting to be added to the MCPTT talk group. For example, the first user can be provided an indication on their mobile device (e.g., within the MCPTT application) that the MCPTT talk group is joinable. In aspects, the indication can include the title of the MCPTT talk group, the geofence within which the MCPTT talk group is joinable, or any other characteristic of the MCPTT talk group. In some cases, the first user is only notified of the MCPTT talk group if they opt in (e.g., through the MCPTT application) to receiving notifications about joinable MCPTT talk groups.

In response to the indication that the MCPTT talk group is joinable, the first user can request to join the talk group. In some cases, this can be performed by accepting a pop-up requesting whether the first user would like to join the MCPTT talk group. In other cases, the first user can search for the MCPTT talk group in an action that is separate from the notification that the MCPTT talk group is joinable. In some cases, the first user can be added to the MCPTT talk group in response to their request to join without approval from the administrator. In other cases, the request initiates a notification to the administrator to accept or reject the request for the first user to join the talk group. If the request is accepted or approval is not needed, the first user can be added to the MCPTT talk group, thereby enabling the first user to communicate with other members of the talk group using MCPTT communication on their device.

Users can similarly be removed from the MCPTT talk group when the location of their mobile device indicates that they have left the geofence. For example, in response to receiving a location estimate that indicates that their mobile device is outside the geofence (e.g., as a result of their device relocating or the geofence relocating), the user can be removed from the MCPTT talk group. As a result, the MCPTT talk group may no longer appear on their device and they may no longer utilize the MCPTT talk group to communicate with other members of the group.

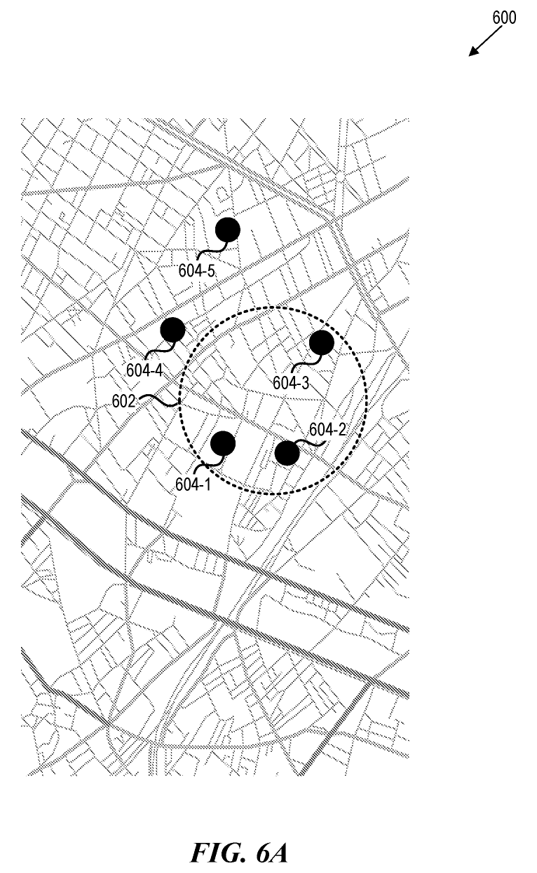

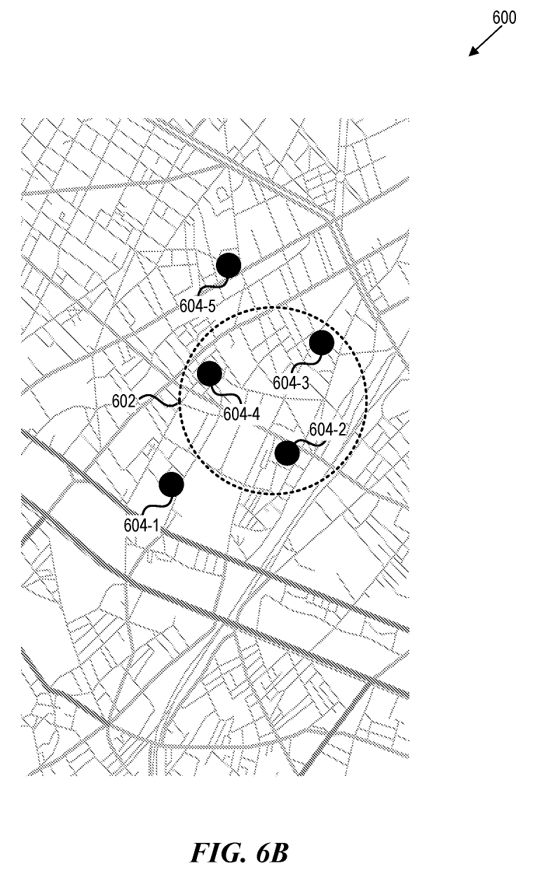

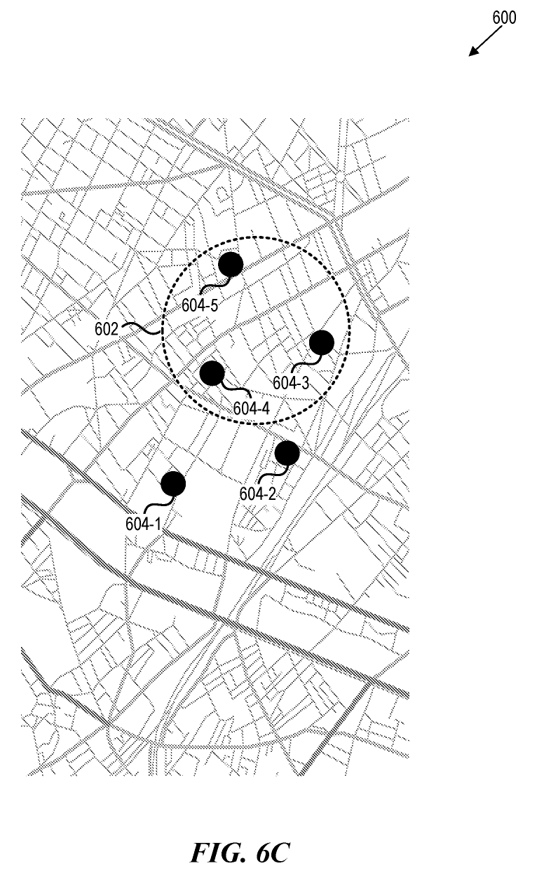

FIGS. 6A-6C illustrate a response site 600 where users are added to or removed from a geofenced MCPTT talk group in accordance with aspects of the present technology. FIGS. 6A-6C illustrate the response site 600 at various points in time. For example, FIG. 6A illustrates the response site 600 at time T1, FIG. 6B illustrates the response site 600 at a later time T2, and FIG. 6C illustrates the response site 600 at an even later time T3.

Referring first to FIG. 6A, an MCPTT talk group is provisioned at the response site 600. The MCPTT talk group is associated with a geofence located at a particular location within the response site 600. Various users 604 (e.g., user 604-1, user 604-2, user 604-3, user 604-4, and user 604-5) with respective mobile devices are located at the response site 600. As illustrated, user 604-1, user 604-2, and user 604-3 are located within the geofence 602, and user 604-4 and user 604-5 are located outside the geofence 602. In aspects, user 604-1 and user 604-2 are members of the MCPTT talk group. In some cases, these users were initially specified by the administrator, which can be user 604-1, user 604-2, or any other user/entity, as members of the MCPTT talk group. In other cases, user 604-1 or user 604-2 joined the MCPTT talk group (e.g., by initiating a request to join the MCPTT talk group on their device) in response to being located within the geofence 602.

While user 604-3 is located within the geofence 602, user 604-3 is not a member of the MCPTT talk group (e.g., because user 604-3 has never requested to join the MCPTT talk group or was never added to the MCPTT talk group by the administrator). This could be because user 604-3 received the notification that the MCPTT talk group was joinable but decided not to join or because user 604-3 never received the notification that the MCPTT talk group was joinable because they have notifications about joinable talk groups disabled. User 604-4 and user 604-5 are currently located outside the geofence 602. As a result, user 604-4 and user 604-5 are unable to join the MCPTT talk group. Thus, communication in the MCPTT talk group takes place between user 604-1 and user 604-2.

Referring now to FIG. 6B, user 604-1 relocates to outside the geofence 602 and user 604-4 moves into the geofence 602. As a result of user 604-1 exiting the geofence 602, user 604-1 can be removed from the MCPTT talk group. This removal can take place without an explicit removal by the administrator. Similarly, user 604-4 is added to the MCPTT talk group in response to a request to join the MCPTT talk group. For example, when user 604-4 enters the geofence 602, he or she can receive a notification that the MCPTT talk group is joinable. In response to the notification, user 604-4 can request admission into the MCPTT talk group. In some cases, this request must be approved by the administrator before user 604-4 is added to the MCPTT talk group. In other cases, user 604-4 can be added to the MCPTT talk group without approval from the administrator. While user 604-3 is still located within the geofence 602, user 604-3 may not be a member of the MCPTT talk group (e.g., due to no request to join the group being made). Thus, the communication in the talk group can now take place between user 604-2 and user 604-4.

Referring now to FIG. 6C, the geofence 602 is moved such that user 604-3, user 604-4, and user 604-5 are located within the geofence. The geofence 602 can be moved in response to an additional communication from the administrator or another source (e.g., a weather application tracking a weather event associated with the geofence) updating the location of the geofence 602. As a result of the geofence 602 relocating, user 604-2 is outside the geofence 602, and user 604-5 has entered the geofence 602. Thus, user 604-2 can be removed from the MCPTT talk group (e.g., without an explicit removal by the administrator). This removal can occur even if user 604-2 does not move due to the relocation of the geofence 602. User 604-5 is added to the MCPTT talk group in response to a request to join the MCPTT talk group (e.g., and approval by the administrator, if necessary) due to user 604-5 being located within the geofence 602. Moreover, user 604-3 can have joined the MCPTT talk group by initiating a request to join the MCPTT talk group, thereby making user 604-3 a member of the MCPTT talk group. Thus, the communication in the talk group can now take place between user 604-3, user 604-4, and user 604-5.

Although not illustrated, the MCPTT talk group can be automatically deleted when the MCPTT talk group reaches an expiration time. For example, the administrator can specify an expiration time of the MCPTT talk group. Alternatively, the MCPTT talk group can be set with a default expiration time. For example, the default expiration time can include a period of time since the MCPTT talk group was created or an amount of time since the MCPTT talk group was used to communicate. In any event, once the expiration time is reached, the MCPTT talk group can be dissolved without additional direction from the administrator. For example, the MCPTT talk group can be deleted from the server of the MCPTT service provider such that the users 604 can no longer communicate using the MCPTT talk group.

### Computer System

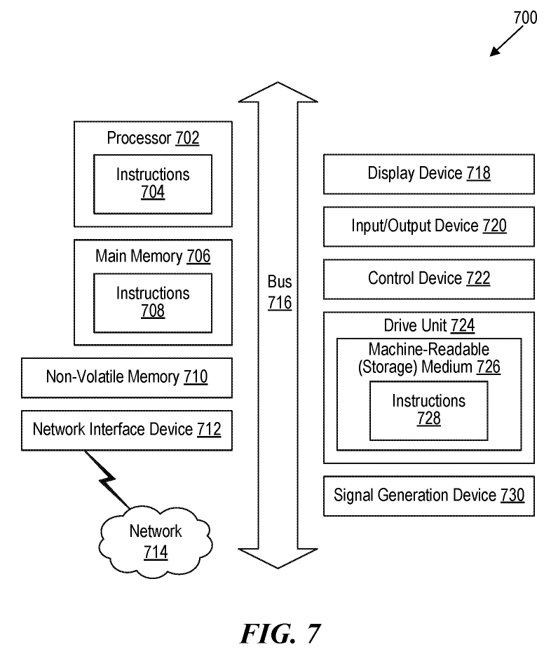

FIG. 7 illustrates an example of a computing system 700 in which at least some operations described herein can be implemented. As shown, the computing system 700 can include one or more processors 702, main memory 706, non-volatile memory 710, a network interface device 712, a display device 718, an input/output device 720, a control device 722 (e.g., keyboard and pointing device), a drive unit 724 that includes a machine-readable (storage) medium 726, and a signal generation device 730 that are communicatively connected to a bus 716. The bus 716 represents one or more physical buses and/or point-to-point connections that are connected by appropriate bridges, adapters, or controllers. Various common components (e.g., cache memory) are omitted from FIG. 7 for brevity. Instead, the computing system 700 is intended to illustrate a hardware device on which components illustrated or described relative to the examples of the figures and any other components described in this specification can be implemented.

The computing system 700 can take any suitable physical form. For example, the computing system 700 can share a similar architecture as that of a server computer, personal computer (PC), tablet computer, mobile telephone, game console, music player, wearable electronic device, network-connected (“smart”) device (e.g., a television or home assistant device), AR/VR system (e.g., head-mounted display), or any electronic device capable of executing a set of instructions that specifies action(s) to be taken by the computing system 700. In some implementations, the computing system 700 can be an embedded computing system, a system-on-chip (SOC), a single-board computing (SBC) system, or a distributed system such as a mesh of computing systems, or it can include one or more cloud components in one or more networks. Where appropriate, one or more computing systems 700 can perform operations in real time, in near real time, or in batch mode.

The network interface device 712 enables the computing system 700 to mediate data in a network 714 with an entity that is external to the computing system 700 through any communication protocol supported by the computing system 700 and the external entity. Examples of the network interface device 712 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 706, non-volatile memory 710, machine-readable (storage) medium 726) can be local, remote, or distributed. Although shown as a single medium, the machine-readable (storage) medium 726 can include multiple media (e.g., a centralized/distributed database and/or associated caches and servers) that store one or more sets of instructions 728. The machine-readable (storage) medium 726 can include any medium that is capable of storing, encoding, or carrying a set of instructions for execution by the computing system 700. The machine-readable (storage) medium 726 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 710, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 704, 708, 728) set at various times in various memory and storage devices in computing device(s). When read and executed by the processor 702, the instruction(s) cause the computing system 700 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the Detailed Description above using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein unless the Detailed Description above explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

We claim:

1. A method comprising:
receiving, from an administrator of a Mission Critical Push-to-Talk (MCPTT) talk group, a request to create the MCPTT talk group usable to communicate between members of the MCPTT talk group,
wherein the request to create the MCPTT talk group includes:
an indication of a geofence within which the members of the MCPTT talk group can communicate; and
an indication that the MCPTT talk group is to be joinable by a user when a mobile device of the user is within the geofence;
in response to receiving the request to create the MCPTT talk group, creating the MCPTT talk group such that the MCPTT talk group is joinable by the user when the mobile device of the user is within the geofence;
receiving a location estimate of a first mobile device, the location estimate indicating that the first mobile device is within the geofence; and
in response to receiving the location estimate indicating that the first mobile device is within the geofence, adding a first user of the first mobile device to the MCPTT talk group such that the first mobile device can be used to communicate with the members of the MCPTT talk group,
wherein the first user is added to the MCPTT talk group exclusive of a selective addition of the first user to the MCPTT talk group by the administrator of the MCPTT talk group.

2. The method of claim 1, further comprising:
in response to receiving the location estimate indicating that the first mobile device is within the geofence, transmitting, to the first mobile device, an indication that the MCPTT talk group is joinable; and
receiving, from the first mobile device, a request for the first user to join the MCPTT talk group,
wherein the first user is added to the MCPTT talk group in response to receiving the request for the first user to join the MCPTT talk group.

3. The method of claim 1, wherein:
the request to create the MCPTT talk group includes an expiration time at which the MCPTT talk group is to be deleted; and
the method further comprises, in response to reaching the expiration time, deleting the MCPTT talk group without an additional request from the administrator of the MCPTT talk group to do so.

4. The method of claim 1, further comprising:
after adding the first user to the MCPTT talk group, receiving an additional location estimate of the first mobile device indicating that the first mobile device is located outside the geofence; and
in response to receiving the additional location estimate indicating that the first mobile device is located outside the geofence, removing the first user from the MCPTT talk group exclusive of a selective removal of the first user from the MCPTT talk group by the administrator of the MCPTT talk group.

5. The method of claim 1, wherein:
the MCPTT talk group is created as an empty talk group; and
the members of the MCPTT talk group are added to the MCPTT talk group exclusive of additional direction from the administrator of the MCPTT talk group.

6. The method of claim 1, wherein:
the request to create the MCPTT talk group includes a title of the MCPTT talk group; and
the method further comprises, in response to receiving the location estimate indicating that the first mobile device is within the geofence, transmitting, to the first mobile device, the title of the MCPTT talk group in association with an indication that the MCPTT talk group is joinable.

7. The method of claim 1, wherein the indication of the geofence within which the members of the MCPTT talk group can communicate comprises coordinates of a center of the geofence.

8. The method of claim 1, wherein:
the indication of the geofence within which the members of the MCPTT talk group can communicate is associated with a location of an extreme weather event; and
the method further comprises:
subsequent to receiving the request to create the MCPTT talk group, receiving, from a weather monitoring application, an update to the location of the extreme weather event, and
in response to receiving the update to the location of the extreme weather event, updating a location of the geofence based on the update to the location of the extreme weather event.

9. A system comprising:
at least one processor; and
at least one non-transitory, computer-readable storage medium storing instructions that, when executed by the at least one processor, cause the system to:
receive a request to create a Mission Critical Push-to-Talk (MCPTT) talk group usable to communicate between members of the MCPTT talk group,
wherein the request to create the MCPTT talk group includes an indication of a geofence within which the members of the MCPTT talk group can communicate;
in response to receiving the request to create the MCPTT talk group, create the MCPTT talk group;
receive a location estimate of a first mobile device, the location estimate indicating that the first mobile device is within the geofence;
in response to receiving the location estimate indicating that the first mobile device is within the geofence, transmit, to the first mobile device, an indication that the MCPTT talk group is joinable;
receive, from the first mobile device, a request for a first user of the first mobile device to join the MCPTT talk group; and
in response to receiving the request for the first user to join the MCPTT talk group, add the first user of the first mobile device to the MCPTT talk group such that the first mobile device can be used to communicate with the members of the MCPTT talk group.

10. The system of claim 9, wherein:
the request to create the MCPTT talk group includes an expiration time at which the MCPTT talk group is to be deleted; and
the system is further caused to, in response to reaching the expiration time, delete the MCPTT talk group.

11. The system of claim 9, wherein the system is further caused to:
after adding the first user to the MCPTT talk group, receive an additional location estimate of the first mobile device indicating that the first mobile device is located outside the geofence; and
in response to receiving the additional location estimate indicating that the first mobile device is located outside the geofence, remove the first user from the MCPTT talk group.

12. The system of claim 9, wherein:
the MCPTT talk group is created as an empty talk group; and
the members of the MCPTT talk group are added to the MCPTT talk group exclusive of additional direction from an administrator of the MCPTT talk group.

13. The system of claim 9, wherein:
the request to create the MCPTT talk group includes a title of the MCPTT talk group; and
the system is further caused to, in response to receiving the location estimate indicating that the first mobile device is within the geofence, transmit, to the first mobile device, the title of the MCPTT talk group in association with an indication that the MCPTT talk group is joinable.

14. The system of claim 9, wherein the members of the MCPTT talk group comprise employees of different companies.

15. The system of claim 9, wherein:
the indication of the geofence within which the members of the MCPTT talk group can communicate is associated with a location of an extreme weather event; and
the system is further caused to:
subsequent to receiving the request to create the MCPTT talk group, receive, from a weather monitoring application, an update to the location of the extreme weather event, and
in response to receiving the update to the location of the extreme weather event, update a location of the geofence based on the update to the location of the extreme weather event.

16. At least one non-transitory, computer-readable storage medium storing instructions that, when executed by at least one processor, cause a system to:
receive a request to create a Mission Critical Push-to-Talk (MCPTT) talk group usable to communicate between members of the MCPTT talk group,
wherein the request to create the MCPTT talk group includes an indication of a geofence within which the members of the MCPTT talk group can communicate;
in response to receiving the request to create the MCPTT talk group, create the MCPTT talk group;
receive a location estimate of a first mobile device, the location estimate indicating that the first mobile device is within the geofence;
in response to receiving the location estimate indicating that the first mobile device is within the geofence, transmit, to the first mobile device, an indication that the MCPTT talk group is joinable;
receive, from the first mobile device, a request for a first user of the first mobile device to join the MCPTT talk group; and
in response to receiving the request for the first user to join the MCPTT talk group, add the first user of the first mobile device to the MCPTT talk group such that the first mobile device can be used to communicate with the members of the MCPTT talk group.

17. The at least one non-transitory, computer-readable storage medium of claim 16, wherein:
the request to create the MCPTT talk group includes an expiration time at which the MCPTT talk group is to be deleted; and
the system is further caused to, in response to reaching the expiration time, delete the MCPTT talk group.

18. The at least one non-transitory, computer-readable storage medium of claim 16, wherein the system is further caused to:
after adding the first user to the MCPTT talk group, receive an additional location estimate of the first mobile device indicating that the first mobile device is located outside the geofence; and
in response to receiving the additional location estimate indicating that the first mobile device is located outside the geofence, remove the first user from the MCPTT talk group.

19. The at least one non-transitory, computer-readable storage medium of claim 16, wherein:
the MCPTT talk group is created as an empty talk group; and
the members of the MCPTT talk group are added to the MCPTT talk group exclusive of additional direction from an administrator of the MCPTT talk group.

20. The at least one non-transitory, computer-readable storage medium of claim 16, wherein:
the request to create the MCPTT talk group includes a title of the MCPTT talk group; and
the system is further caused to, in response to receiving the location estimate indicating that the first mobile device is within the geofence, transmit, to the first mobile device, the title of the MCPTT talk group in association with an indication that the MCPTT talk group is joinable.
